(19) United States
(12) Patent Application Publication
(10) Pub. No.: US 2017/0033990 A1
(43) Pub. Date: Feb. 2, 2017

(54) RECORDING MEDIUM, PARAMETER SPECIFYING METHOD AND PARAMETER SPECIFYING DEVICE

(71) Applicant: FUJITSU LIMITED, Kawasaki-shi (JP)

(72) Inventors: Toshihiro SHIMIZU, Sagamihara (JP); Takeshi Yasuie, Kawasaki (JP); Satoshi Munakata, Kawasaki (JP)

(73) Assignee: FUJITSU LIMITED, Kawasaki-shi (JP)

(21) Appl. No.: 15/178,111

(22) Filed: Jun. 9, 2016

(30) Foreign Application Priority Data
Jul. 31, 2015 (JP) 2015-152086

(51) Int. Cl. H04L 12/24; H04L 29/06

(52) U.S. Cl. CPC H04L 41/0813; H04L 67/42; H04L 41/0823; H04L 41/0886

(57) ABSTRACT

A non-transitory computer-readable recording medium having stored therein an access information management program for causing a computer to execute a process includes extracting a parameter from request data based on a storage device configured to store a plurality of pieces of the request data and response data associated with each of the plurality of pieces of the request data, changing a plurality of parameters with a value that is the same as the extracted parameter into values different from each other from among a plurality of parameters included in previous response data that is before target request data including the extracted parameter, and specifying a parameter passed on from the previous response data to the target request data based on a value of a parameter included in request data generated in accordance with a prescribed rule from the response data in which parameter values are changed by the changing.

### CROSS-REFERENCE TO RELATED APPLICATION

This application is based upon and claims the benefit of priority of the prior Japanese Patent Application No. 2015-152086, filed on Jul. 31, 2015, the entire contents of which are incorporated herein by reference.

### FIELD

The embodiments discussed herein are related to a recording medium, a parameter specifying method and a parameter specifying device.

### BACKGROUND

Technologies that allows a server and a client to communicate with each other have been realized. The client transmits a request to the server, and the server transmits a response to the client in response to the request.

The client receives the response from the server and transmits a subsequent request to the server based on the received response. At that time, the client may pass on parameters included in the received response to the subsequently transmitted request receive and transmits the request with the parameters passed on from the response to the server.

Related Art includes a technology of automatizing a series of operations performed on plural screens to reduce burden on users by selecting a communication sequence that frequently appeared in communication history in the past, and reproducing the communication sequence.

Another technology has been proposed that each of virtual web clients sets values of parameters having the same name included in requests after a response included in a scenario by using a value of a parameter received as a response from a web server device (see Patent Document 1 or Patent Document 2 as an example).
Patent Document 1: Japanese Laid-Open Patent Publication No. 2009-087032
Patent Document 2: Japanese Laid-Open Patent Publication No. 2012-248228

### SUMMARY

According to an aspect of the embodiments, a non-transitory computer-readable recording medium having stored therein an access information management program for causing a computer to execute a process includes extracting a parameter from request data based on a storage device configured to store a plurality of pieces of the request data and response data associated with each of the plurality of pieces of the request data, changing a plurality of parameters with a value that is the same as the extracted parameter into values different from each other from among a plurality of parameters included in previous response data that is before target request data including the extracted parameter, and specifying a parameter passed on from the previous response data to the target request data based on a value of a parameter included in request data generated in accordance with a prescribed rule from the response data in which parameter values are changed by the changing.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram illustrating an example of an existing communication environment;

FIG. 2 is a diagram illustrating an example of an access reproduction environment including a parameter specifying device;

FIG. 3 is a diagram illustrating an example of separation of input data;

FIG. 4 is a diagram illustrating an example of a relationship between requests and responses;

FIG. 5 is a diagram illustrating an example of specifying a parameter;

FIG. 6 is a diagram illustrating an example of a request issue program;

FIG. 7 is a diagram illustrating an example of comparison between a response and a request;

FIG. 8 is a flowchart illustrating an example of processing according to the present embodiments;

FIG. 9 is a flowchart illustrating an example of processing to specify a parameter;

FIG. 10 is a flowchart illustrating an example of processing to change a parameter;

FIG. 11 is a flowchart illustrating an example of an operation flow of a pseudo server; and

FIG. 12 is a diagram illustrating an example of a hardware configuration of the parameter specifying device.

### DESCRIPTION OF EMBODIMENTS

Parameters passed on from a response to a request are not necessarily stylized in the response. Therefore, when a response includes plural parameters of the same one value, it is difficult to specify which parameters are to be passed on to the next request.

In the following description, embodiments are explained with reference to the accompanying drawings. In a system in which a client and a sever communicate with each other, the client transmits prescribed request data (e.g., Hypertext Transfer Protocol (HTTP) request) to the server.

In response to the request data, the server transmits response data to the client. In the following description, request data is simply referred to as a request, and response data is simply referred to as a response.

When the client issues a request, the client may pass on a parameter included in a response that has been received from the server (hereinafter referred to as a previous response), and issues the request.

For example, when a parameter to be passed on is written in a fixed format, such as Cookie, it would not be difficult for a client to specify the parameter passed on from a response to a request.

Similarly, when a writing format of a target parameter to be passed on is fixed in a response, such as “a parameter name=a parameter value”, it is also not difficult for a client to specify the parameter passed on from a response to a request.

However, writing formats of a request and a response are not necessarily fixed to one format. Even in this case, it would not be difficult for the client to specify the target parameter when a response includes only one parameter with a value that is the same as that of a target parameter to be passed on to a request.

In this regard, however, when the response includes multiple parameters of a value that is the same as the value of the target parameter passed on to the request, there would be multiple candidates of the target parameter. It is difficult for the client to specify which parameter is passed on from the response to the request from among the multiple candidates.

Even in the above-described case, the present embodiment enables automatic specification of a parameter passed on from a response to a request.

In the following embodiment, an explanation is made on an example of testing access reproduction between a client and a server in a new communication environment in which changes have been made to an existing communication environment that includes a client and a server (e.g., a communication environment in which some changes are added to a server).

For example, when a server is replaced, when server equipment is reinforced, or when some improvements are made to the server, reproduction (test) is performed in such a new communication environment. In order to perform the reproduction in the new communication environment, communication history of requests and responses transmitted/received in the existing communication environment is used.

In order to do so, in the existing communication environment, communication history of requests and responses between the client and the server is captured and stored in a prescribed storage device. Based on this storage device, access reproduction is performed.

The access reproduction is realized by connecting a device to perform the access reproduction (hereinafter referred to as an access reproduction device) to a server in a new communication environment and by performing communication between the access reproduction device and the server.

At that time, the access reproduction device passes on a parameter included in a response received from the server to a request and transmits the request to the server. The access reproduction device, then, receives a response from the server.

A parameter specifying device of the present embodiment specifies a parameter passed on from a response to a request. Information that specifies a parameter passed on from a response to a request is referred to as parameter specifying information.

The parameter specifying device outputs the parameter specifying information to the access reproduction device. The access reproduction device specifies a parameter passed on from a response to a request based on the parameter specifying information, and performs access reproduction. In the following description, details of the embodiment are explained.

### <Example of Storage of Communication History>

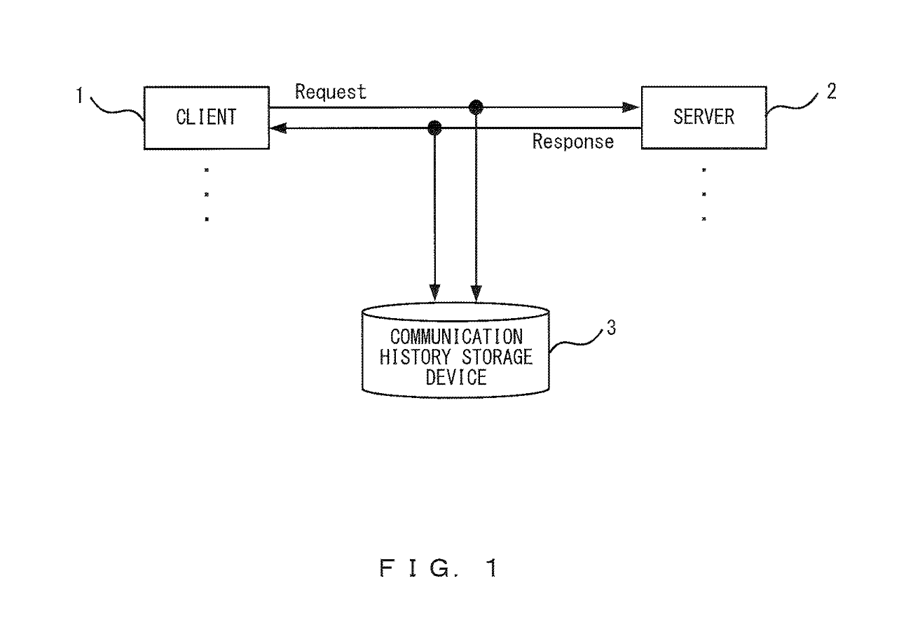

FIG. 1 illustrates an example of an existing communication environment. A client 1 and a server 2 communicate with each other. The client 1 transmits a request to the server 2. The server 2, in response to the request received from the client 1, transmits a response to the client 1.

In FIG. 1 and the following drawings, a request may be represented as “Request” or “Req”. A response may be represented as “Response” or “Res”. The client 1 executes a request issue program. The request issue program passes on a parameter included in a response that has been received earlier (previous response), and issues a request.

A communication history storage device 3 receives and stores a history and communication (communication history) performed between the client 1 and the server 2. In the communication history, a request transmitted from the client 1 to the server 2 and a response that the server 2 transmits in response to the request to the client 1 are associated as one set.

The client 1 and the server 2 communicate with each other. As a result, sets of a request and a response are accumulated in a communication history storage device 3. A series of communications performed between the client 1 and the server 2 is referred to as a session. The communication history storage device 3 is one example of storage devices.

A session is a series of communications in which requests and responses are exchanged. In the present embodiment, a communication history includes plural sessions. Sets of a request and a response are associated with a session and are stored.

In addition, when there are clients of multiple users, sets of a request and a response are associated with a session of each client and are stored in the communication history storage device 3. The communication history stored in the communication history storage device 3 is also referred to as capture data.

### <Example of Access Reproduction System>

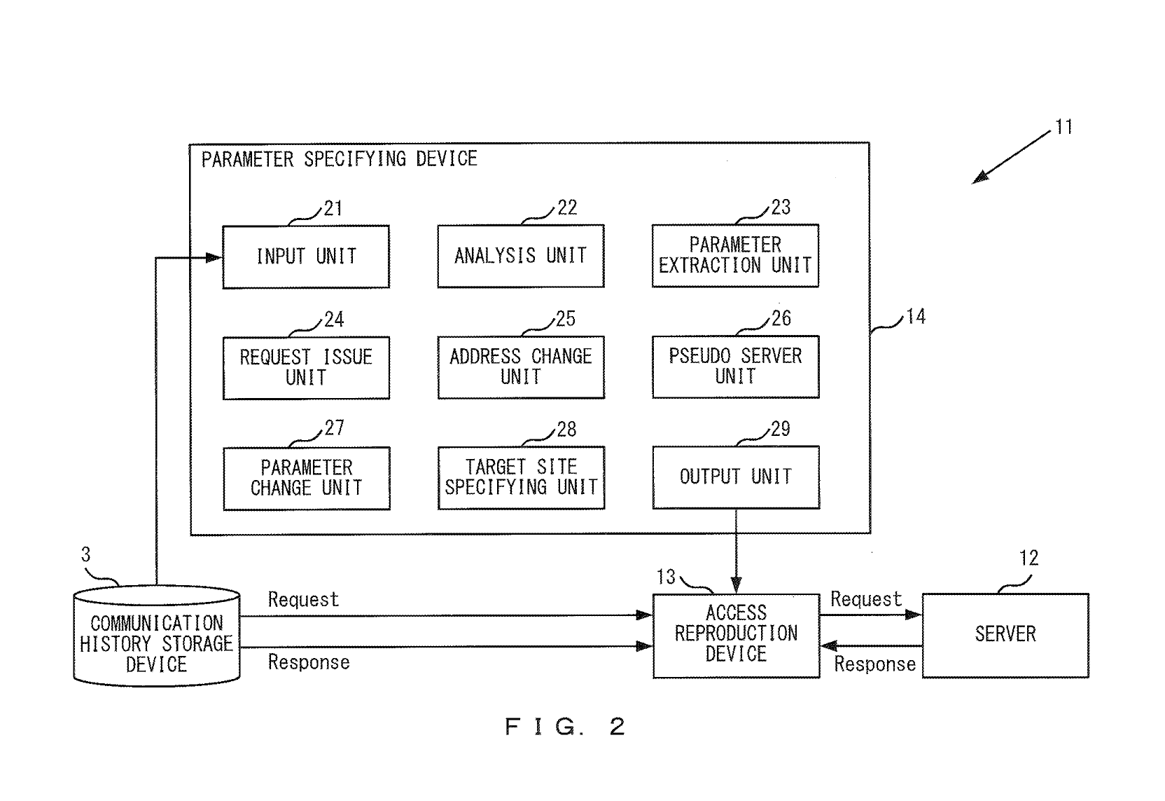

FIG. 2 illustrates an example of an access reproduction environment 11. The access reproduction environment 11 in FIG. 2 includes a communication history storage device 3, a server 12, an access reproduction device 13, and a parameter specifying device 14. The communication history storage device 3 is the same as the communication history storage device 3 in FIG. 1.

The server 12 is a server to which changes are made to the server 2 in FIG. 1. The access reproduction device 13 performs access reproduction in connection with this server 12 by using requests and responses stored in the communication history storage device 3. In order to do so, the access reproduction device 13 sequentially receives inputs of requests and responses in sets from the communication history storage device 3.

The access reproduction device 13 analyzes the input requests and divides the requests with respect to each session. The access reproduction device 13 also issues a request to which a parameter is passed on from a previous response of an input request and transmits the request to the server 12. In response to the request, the server 12 transmits a response to the access reproduction device 13.

In the present embodiment, a parameter may be a number with prescribed digits, or a string of letters including prescribed letters.

The access reproduction device 13 compares the response received from the server 12 with the response that is input from the communication history storage device 3. By doing this, the access reproduction device 13 carries out access reproduction under a new communication environment in which the server 12 is used.

The parameter specifying device 14 specifies a parameter passed on from a response (previous response) to a request (hereinafter occasionally referred to as a target request).

In the present embodiment, the parameter specifying device 14 specifies a site in which a parameter passed on is written in the response in which the parameter passed on to the request is written. Information on a site of parameter passed on is hereinafter referred to as target site information.

A request that receives a parameter (target request) may include plural parameters that receive values from a previous response. In the following description, a parameter in a request that receives a value from a previous response may be referred to as a receiving parameter.

The parameter specifying device 14 specifies sites in the previous response at which parameters passed on are present for each receiving parameter in each request. In one request, there may be only one parameter that receives a value from a previous response.

In this case, the parameter specifying device 14 specifies the site in the previous response at which the parameter passed on to the only one parameter is present. In the following description, pieces of target site information of parameters in requests may be collectively referred to as parameter specifying information.

The access reproduction device 13 inputs parameter specifying information from the parameter specifying device 14. Based on the parameter specifying information, the access reproduction device 13 specifies parameters that a request input from the communication history storage device 3 receives from a response and has the response pass on the parameters to the request.

The access reproduction device 13 receives inputs of requests and responses sequentially from the communication history storage device 3. The access reproduction device 13 transmits to the server 12 the request that received the value of the parameter from the previous response. The access reproduction device 13, afterwards, compares the response input from the communication history storage device 13 with the response input from the server 12.

The parameter specifying device 14 includes an input unit 21, an analysis unit 22, a parameter extraction unit 23, a request issue unit 24, an address change unit 25, a pseudo server unit 26, a parameter change unit 27, a target site specifying unit 28, and an output unit 29.

The input unit 21 receives an input of communication history stored in the communication history storage device 3. The communication history includes plural sets of request and response. As described above, each of the sets of communication history is associated with a session. It should be noted that the parameter specifying device 14 may store communication history that the input unit 21 received as an input.

The analysis unit 22 analyzes each of the sets of communication history that is input through the input unit 21, and separates the sets by session.

The parameter extraction unit 23 segmentalizes the contents written in the requests in each set of communication history into words. For example, the parameter extraction unit 23 segmentalizes a request into words by using morphological analysis. The parameter extraction unit 23 is an example of an extraction unit.

From among the segmentalized words, the parameter extraction unit 23 extracts a word that is possibly a parameter as a receiving parameter. Numbers or particular strings of letters are an example of the word that is possibly a parameter.

The request issue unit 24 issues a request by executing a request issue program. The request issue program is, for example, a program that operates in an HTTP client.

The request issue program issues the request in accordance with a prescribed rule based on the written contents. The processing carried out by the request issue unit 24 may be referred to as request issue processing.

The request issue unit 24 provides the issued request to the pseudo server unit 26. The address change unit 25 changes the address of the request to the pseudo server unit 26. This is because when the address of the request issued by the request issue unit 24 is not the pseudo server unit 26, the request issued by the request issue unit 24 will not be provided to the pseudo server unit 26.

The request issued by the request issue unit 24 has its address changed and is provided to the pseudo server unit 26. The processing that the address change unit 25 performs may be referred to as address change processing.

In response to the request issued by the request issue unit 24, the pseudo server unit 26 outputs a request to the request issue unit 24. The pseudo server unit 26 is a unit that realizes operations of the server 12 artificially by a program. The processing that the pseudo server unit 26 performs may be referred to as pseudo server processing.

The request issue processing, the address change processing and the pseudo server processing are realized in the parameter specifying device 14 by the parameter specifying device 14 executing the program according to the present embodiment (parameter specifying program).

The parameter change unit 27 detects whether the previous response includes parameters with a value that is the same as the value of the receiving parameter extracted by the parameter extraction unit 23. The parameter change unit 27 is an example of a change unit.

In the present embodiment, the parameter change unit 27 segmentalizes a response into words by using morphological analysis, extracts a word that is possibly a parameter from the segmentalized words, and detects the words that is possibly a parameter as a parameter. In the following description, the detected parameter in a response is referred to as a parameter candidate.

When plural parameter candidates are detected in a single previous response, the parameter change unit 27 changes the values of the detected parameter candidates into values that are different from each other.

The parameter change unit 27 changes the values of the parameter candidates in each of plural responses. Afterwards, the parameter change unit 27 registers with the pseudo server unit 26 the responses in which values of the parameter candidates are changed.

In the present embodiment, when the values of the parameter candidates are written in numbers, the parameter change unit 27 changes the values (numbers) of the parameter candidates so that the numbers are in the same number of digits but different values.

When each of the values of the parameter candidates are a string of letters, the parameter change unit 27 changes the values (string of letters) of the parameter candidates so that the number of letters is the same but the order of the string of letters are different from one another.

Depending on the request issue program, when the number of digits or the length of the string of letters in a parameter passed on from a response to a request is different, the parameter may not be regarded as parameters passed on from a response to a request.

For that reason, the parameter change unit 27 changes plural parameter candidates included in a previous response so that the number of digits or the length of the string of letters is the same but the values are different from each other.

In the present embodiment, the parameter change unit 27 registers with the pseudo server unit 26 plural sets each including a request and a changed response in the same session. The request and response that are registered are associated with each other.

When the pseudo server unit 26 receives a request from the request issue unit 24, the pseudo server unit 26 provides the request issue unit 24 with a response associated with the received request based on the association between the request and response. The values of parameter candidates included in the response have been changed into values that are different from each other.

The target site specifying unit 28 observes the response provided from the pseudo server unit 26 to the request issue unit 24 and the request that received a parameter from the response and that is provided from the request issue unit 24 to the pseudo server unit 26.

The target site specifying unit 28 specifies a target site of parameters based on the observed response and request. The target site specifying unit 28 is an example of a specifying unit.

The target site specifying unit 28 specifies a target site from the previous response for each receiving parameter in each request that the input unit 21 received from the communication history storage device 3.

The output unit 29 outputs the parameter specifying information that collectively gathers pieces of target site information for every receiving parameters of every requests to the access reproduction device 13.

### <Separation by Each Session>

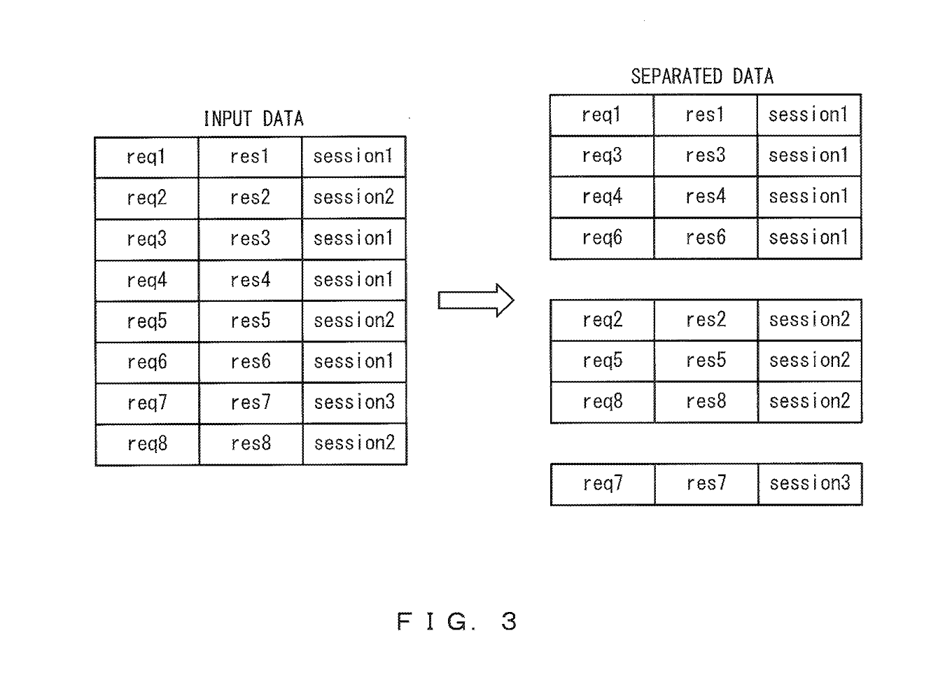

FIG. 3 illustrates an example of communication history (sets of request and response) that the input unit 21 received from the communication history storage device 3. In FIG. 3, communication history that the input unit 21 input is represented as input data.

Each set of request and response is associated with a session. The analysis unit 22 separates the input data by session. In FIG. 3, sets of request and response separated by session are represented as “separated data”.

<Example of Parameter Passed on from Response to Request>

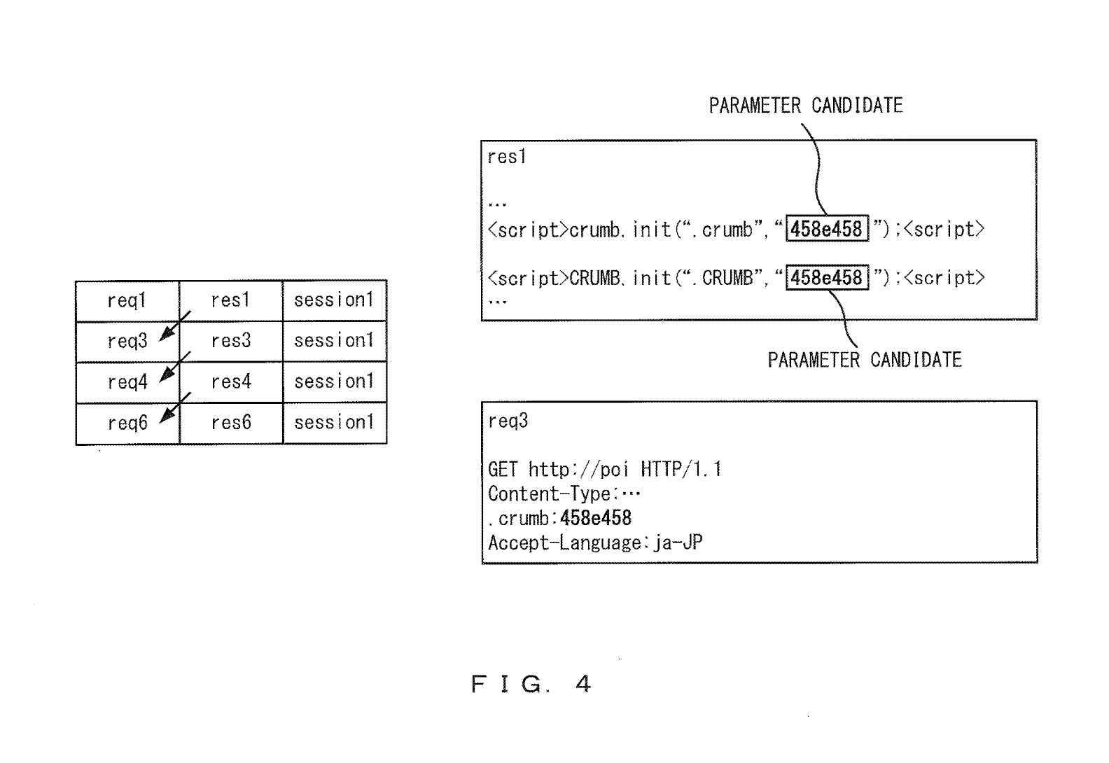

FIG. 4 illustrates an example of sets of request and response for session 1 separated by the analysis unit 22. As indicated by an arrow in FIG. 4, parameters included in response 1 (res1 in FIG. 4) is passed on to request 3 (req3 in FIG. 4).

The request issue unit 24 executes a request issue program. When the request issue program executes a part that issues request 3, request 3 receives parameters from response 1 and a new request is issued.

FIG. 4 illustrates that response 1 includes two candidates of parameter (hereinafter occasionally referred to as parameter candidate) passed on to request 3. Request 3 represents a part that issues this request 3 in the request issue program.

The parameter extraction unit 23 segmentalizes the part of request 3 into words by using morphological analysis. The parameter extraction unit 23, then, extracts a receiving parameter. For example, “http” is not likely to be a parameter passed on from a response to a request.

In addition, “GET” is a command, and is not likely to be a parameter passed on from a response to a request. From among the segmentalized words, the parameter extraction unit 23 may exclude words that are unlikely to be passed on from a response to a request from parameters to be extracted.

Meanwhile, “458e458” is a string of letters and is likely to be a parameter. In this case, the parameter extraction unit 23 extracts “458e458” as a receiving parameter. It should be noted that the parameter extraction unit 23 may extract all words obtained by morphological analysis of the part of request 3 as a receiving parameter.

In the case of FIG. 4, previous response 1 includes two of “458e458” that are extracted as receiving parameters. For that reason, it is difficult to specify which of the two parameters included in the previous response 1 is passed on as “458e458” in request 3.

### <Example of Specifying Receiving Parameter>

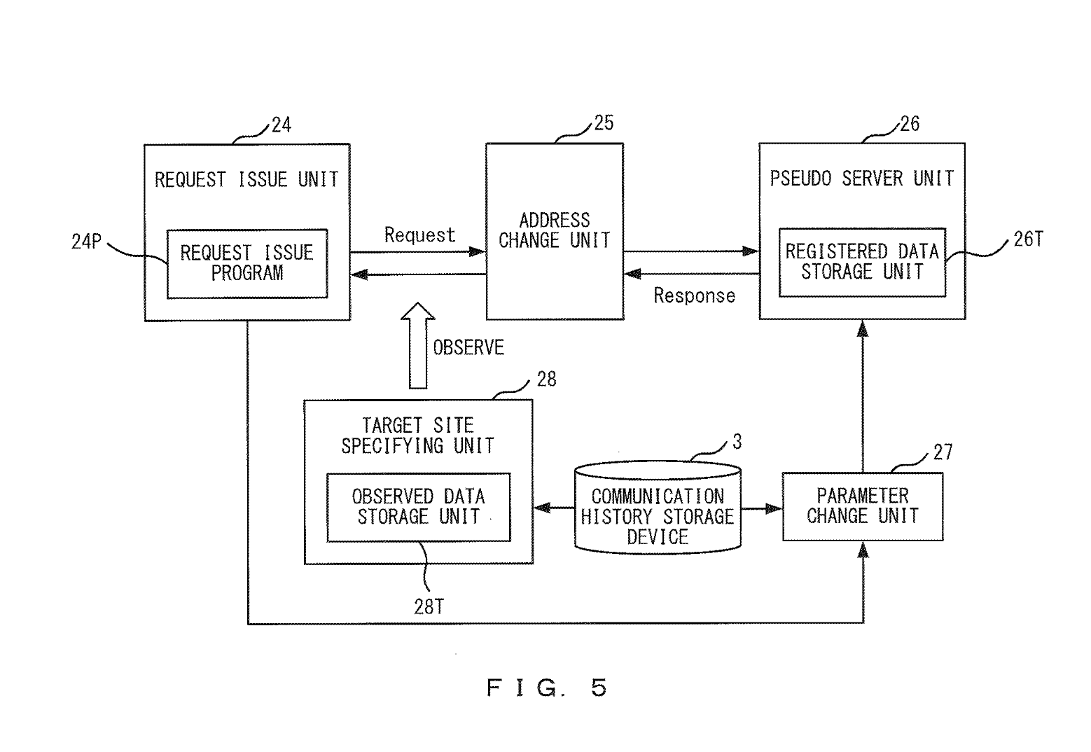

Next, specifying processing of a parameter passed on from a response (previous response) to a request (target request) is explained with reference to an example in FIG. 5. The request issue unit 24 executes a request issue program 24P. A part to issue a request is written in the request issue program 24P.

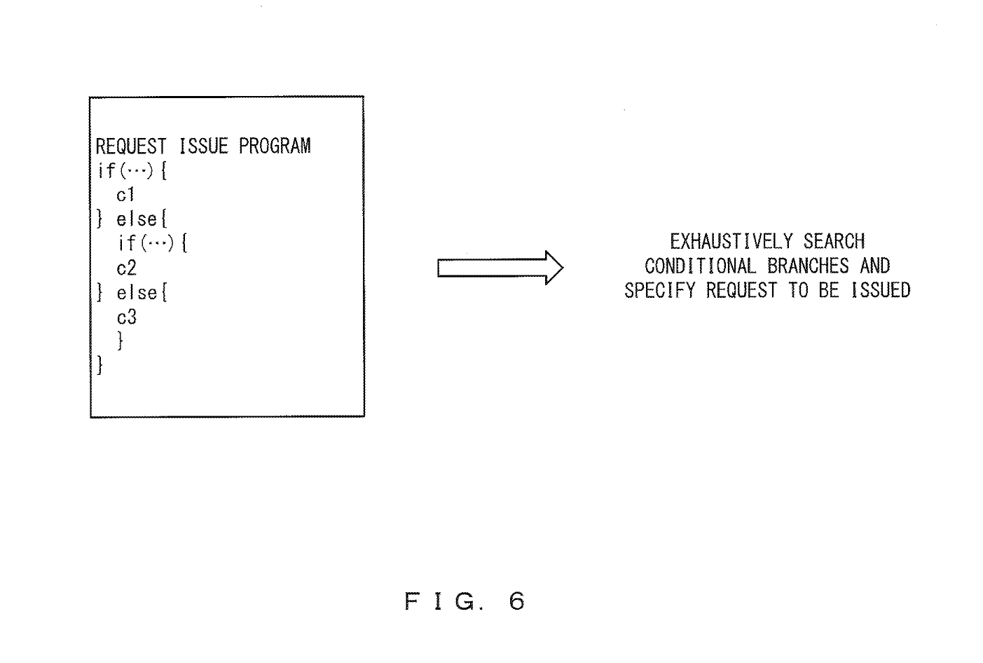

FIG. 6 illustrates an example of the request issue program 24P. The request issue program 24P in the example of FIG. 6 includes a conditional branch (if). What is executed by the program is written in the branch destinations of the conditional branch.

A part to issue a request is written in each of the branch destinations of the conditional branch. The parameter change unit 27 exhaustively searches all branch destinations of every conditional branches included in the request issue program 24P, and specifies all requests included in the request issue program 24P.

For example, the example of FIG. 6 assumes that request 1 is included in “c1” that is a branch destination of the first conditional branch, request 2 is included in “c2” that is a branch destination of the second conditional branch, and request 3 is included in “c3” that is a branch destination of the third conditional branch.

In this case, the parameter change unit 27 exhaustively searches all conditional branches included in the request issue program 24P, and specifies the above-described request 1, request 2, and request 3.

As illustrated in the example of FIG. 5, the parameter change unit 27 receives an input of communication history (sets of request and response) from the communication history storage device 3. It should be noted that when the parameter specifying device 14 stores the communication history, the parameter change unit 27 may receive an input of the stored communication history.

In the input communication history, the parameter change unit 27 changes a parameter in a response associated with a request specified by exhaustively searching in the request issue program 24P.

The parameter change unit 27 registers with a registered data storage unit 26T of the pseudo server unit 26 the request and the changed response as a set. The pseudo server unit 26 provides the request issue unit 24 with a response associated with the request input from the request issue unit 24 by referencing the registered data storage unit 26T.

The address change unit 25 changes an address of a request output from the request issue unit 24. The request output from the request issue unit 24 includes an address. This address is an address written in the request, and it does not address the pseudo server unit 26.

Therefore, the address change unit 25 changes the address to which the request issue unit 24 provides the request into the pseudo server unit 26. As a result, the pseudo server unit 26 receives the request from the request issue unit 24.

The address change unit 25 may be a unit in which a program realizes a “Proxy” function as an example. It should be noted that an address of a request may be changed to the pseudo server unit 26 by the request issue unit 24 when it issues the request.

When the request issue unit 24 executes the request issue program 24P, a request is issued. The issued request has its address changed by the address change unit 25 and is received by the pseudo server unit 26.

The pseudo server unit 26 extracts a response associated with the received request by referencing the registered data storage unit 26T. The pseudo server unit 26 provides the extracted response to the request issue unit 24.

In the response in the registered data storage unit 26T that the pseudo server unit 26 references, values of parameter candidates are changed by parameter change unit 27 so that the vales are different from each other. Therefore, when the values of parameter candidates in the response associated with the received request are changed, the pseudo server unit 26 provides the request issue unit 24 with the response with changed parameters.

The target site specifying unit 28 observes the request that the request issue unit 24 provided to the pseudo server unit 26 and the response that the pseudo server unit 26 provided to the request issue unit 24. The target site specifying unit 28 stores the observed request and response as a set in an observed data storage unit 28T.

The request issue unit 24 issues a request by executing the request issue program 24P. At that time, the issued request includes parameters passed on from the received response.

As described above, the response received by the request issue unit 24 may include plural parameter candidates. In this case, the plural parameter candidates included in the response are changed into values that are different from each other by the parameter change unit 27.

parameters passed on to the request issued by the request issue unit 24 are parameters with values that are different from each other in the response. The request issued by the request issue unit 24 is observed by the target site specifying unit 28 and is stored in the observed data storage unit 28T together with the response from the pseudo server unit 26.

The target site specifying unit 28 sequentially stores in the observed data storage unit 28T responses provided from the pseudo server unit 26 to the request issue unit 24 and requests provided from the request issue unit 24 to the pseudo server unit 26.

Operations of the target site specifying unit 28 may be realized by processing (hereinafter occasionally referred to as target site specifying processing) of the parameter specifying program according to the present embodiment. Operations in the example of FIG. 5 may be realized by each processing of the parameter specifying program.

For example, request issue processing provides a request to pseudo server processing. The pseudo server processing processes the response and provides request issue processing with a response in which values of parameter are changed.

The request issue processing provides pseudo server processing with the request that received a parameter from the response. The target site specifying processing observes exchange of the request and the response between the request issue processing and the pseudo server processing and specifies the parameter passed on from the response to the request.

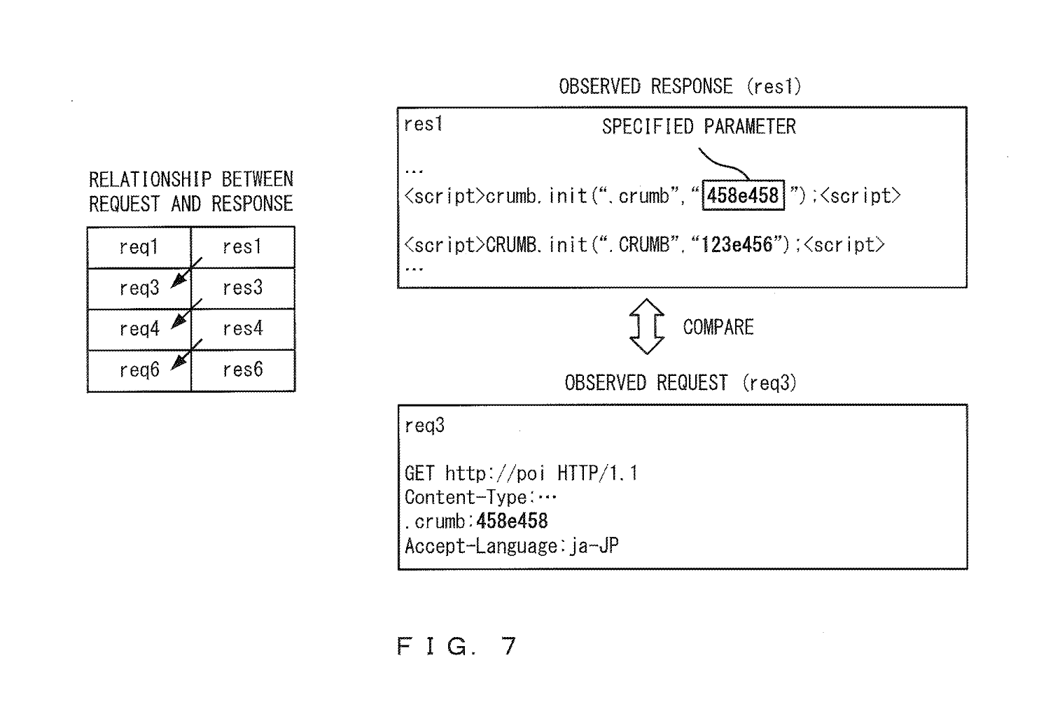

FIG. 7 illustrates an example of a relationship between a request and a response stored in the observed data storage unit 28T. In the example of FIG. 7, the request issue unit 24 receives a parameter from response 1 (res1) and issues request 3 (req3).

Values of parameter candidates included in response 1 are changed into values that are different from each other by the parameter change unit 27. One value is 123e456″ and another value is “458e458”.

Meanwhile, the receiving parameter included in request 3 is “458e458”. Accordingly, the target site specifying unit 28 specifies the parameter candidate “458e458” that has a value that is the same as the receiving parameter “458e458”.

As a result, the target site specifying unit 28 can specify the site of a parameter passed on to request 1 in response 3. Consequently, a parameter passed on from response 1 to request 3 is specified.

In the example of FIG. 7, an example is explained in which response 1 that is the previous response of request 3 includes two parameter candidates. However, there may be a case in which three or more parameter candidates are included in the previous response, response 1.

In this case, similarly, the pseudo server unit 26 has the parameter change unit 27 change the three or more parameter candidates included in response 1 into values that are different from each other. The target site specifying unit 28 specifies a parameter candidate with a value that is the same as the value of the receiving parameter included in request 3. As a result, the target site specifying unit 28 can specify the site of a parameter passed on to request 3 in response 1.

In addition, in the example of FIG. 7, response 3 (res3) and response 1 (res1) are previous responses of request 4 (req4). Response 3 is a previous response that is the last response before request 4. Response 1 is a previous response that is second to the last response before request 4.

The target site specifying unit 28 determines whether response 3 that is a previous response that is the last response before request 4 includes a parameter candidate with a value that is the same as the receiving parameter included in request 4.

When response 3 does not include a parameter candidate with a value that is the same as the receiving parameter included in request 4, request 4 does not receive a parameter from response 3. In this case, the target site specifying unit 28 determines whether a parameter candidate is included in another previous response, response 1, which is second to the last response before request 4.

When response 1 includes a parameter candidate with a value that is the same as the receiving parameter included in request 4, the target site specifying unit 28 specifies a site of parameter passed on to request 4 in response 1 that is second to the last response.

When the target site specifying unit 28 does not detect a receiving parameter with a value that is the same as a parameter in a request in a response that is the last response before the request or a response that is second to the last response before the request, the target site specifying unit 28 sequentially detects parameter candidates from previous responses that are prior to second to the last response.

In this manner, the target site specifying unit 28 can specify a site of parameter passed on to a request not only from a response that is that is the last response before the request but also from a response that is second to the last or more prior response before the request.

### Example of Flowchart of Present Embodiment

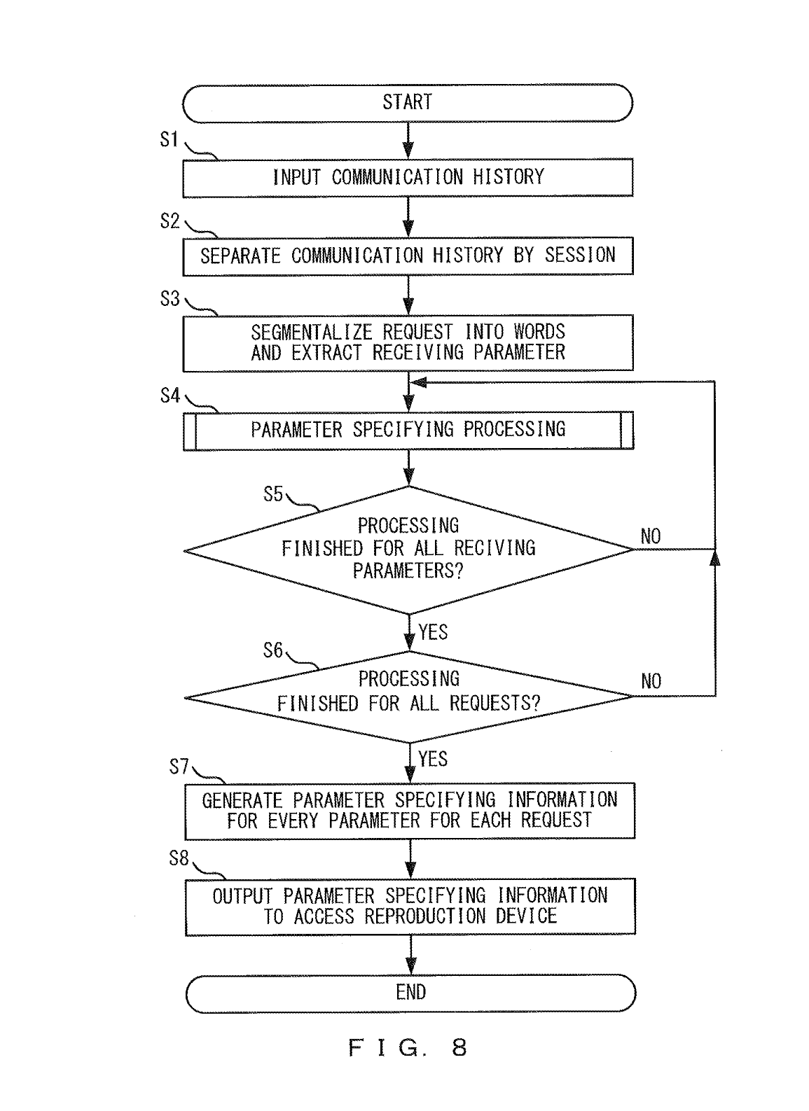

Next, an example of processing according to the present embodiment is explained with reference to a flowchart in FIG. 8. The input unit 21 of the parameter specifying device 14 receives an input of communication history (sets of request and response) from the communication history storage device 3 (step S1). At that time, the input communication history may be stored in the parameter specifying device 14.

Each set of request and response is associated with a session. The analysis unit 22 separates the sets of request and response by session (step S2). Processing in step S3 is performed for each session into which the sets are separated.

One session includes plural sets of request and response. The parameter extraction unit 23 segmentalizes a request and a response into words by morphological analysis as an example, and extracts a receiving parameter (step S3). The processing in step S3 is an example of extraction processing.

From the previous response, the target site specifying unit 28 specifies a parameter with a value that is the same as the extracted receiving parameter as a parameter candidate (step S4). The processing in step S4 is referred to as parameter specifying processing.

One request includes one or more receiving parameters. One request may include plural receiving parameters. In this case, the target site specifying unit 28 determines whether the parameter specifying processing is performed for every receiving parameters (step S5).

When the parameter specifying processing is not performed for every receiving parameters included in one request (NO in step S5), the processing goes back to step S4. Consequently, the parameter specifying processing is performed for every receiving parameters in a request.

When the parameter specifying processing is not performed for every receiving parameters included in one request (YES in step S5), the target site specifying unit 28 determines whether the processing is ended for all requests (step S6).

When the parameter specifying processing is not performed for all requests (NO in step S6), the processing goes back to step S4. The processing in step S4 to step S6 is repeated until the parameter specifying processing is performed for every receiving parameters in all requests.

The target site specifying unit 28 generates parameter specifying information that collectively gathers pieces of target site information that specifies sites of parameter in a previous response for each request and for each receiving parameter (step S7). The processing in step S7 is an example of specifying processing.

The output unit 29 outputs the parameter specifying information to the access reproduction device 13 (step S8). Consequently, based on the parameter specifying information, the access reproduction device 13 can transmit a request that received a parameter from the previous response to the server 12.

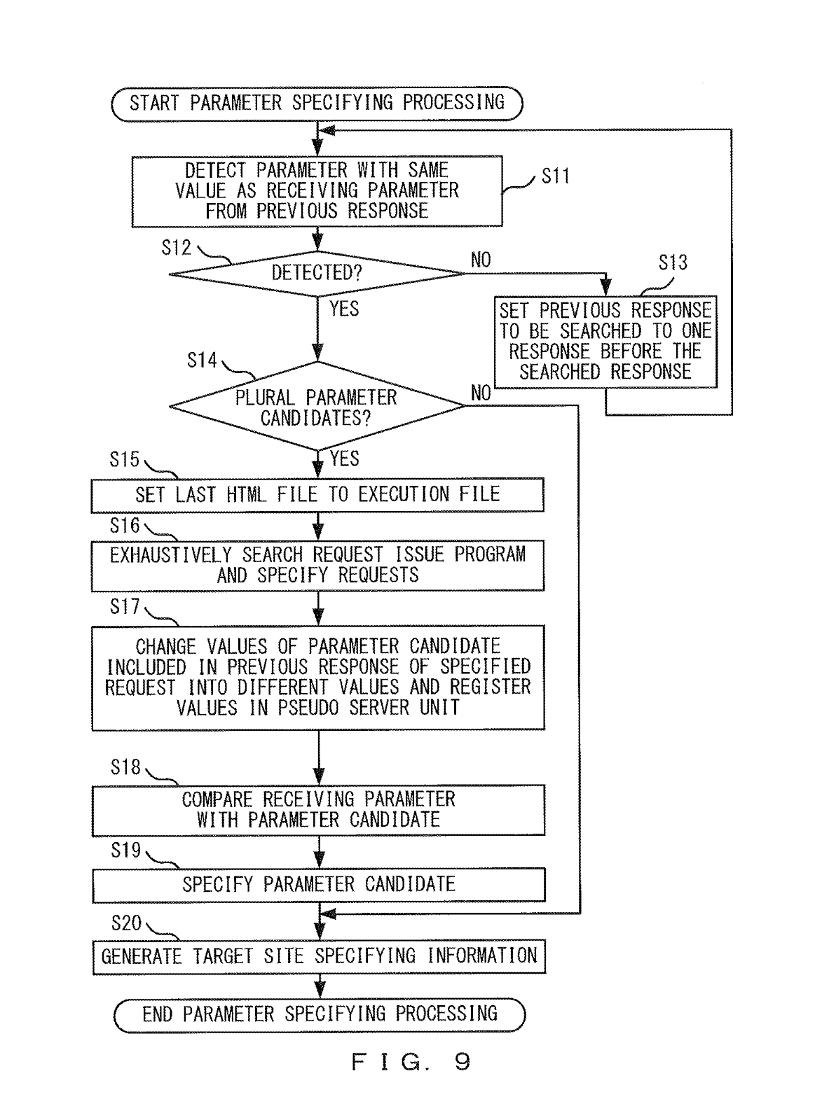

Next, receiving parameter processing in step S4 is explained with reference to an example in FIG. 9. The target site specifying unit 28 searches for whether a parameter with a value that is the same as a receiving parameter included in a request in the communication history storage device 3 (step S11).

The previous response to be searched is initially set to be the last response before the request. The target site specifying unit 28 determines whether the parameter with a value that is the same as the receiving parameter is detected in the last response before the request (step S12).

When step S12 is NO, the request does not receive a parameter from the last response before the request. Then, the target site specifying unit 28 sets the previous response to be searched to one response before the searched response (step S13). Afterwards, the processing goes back to step S11.

When step S12 is YES, the target site specifying unit 28 determines whether there are plural receiving parameters (step S14). When there is only one receiving parameter (NO in step S14), the parameter passed on from the response to the request is uniquely determined. In this case, the processing moves on to step S20, which is explained later.

The request issue unit 24 sets the last Hyper Text Makeup Language (HTML) file to be an execution file (step S15). As a result, the request issue program 24P is set in the request issue unit 24.

It should be noted that when a parameter passed on from a response to a request is not detected on the basis of the last HTML file, the request issue unit 24 may detect the parameter by setting an HTML file that is further before the last HTML file. Moreover, the execution file to be set may be a file other than an HTML file. The execution file to be set may be a text file (a file of text data) as an example.

The parameter change unit 27 exhaustively searches the conditional branches in the request issue program 24P and specifies all requests included in the request issue program 24P (step S16).

The parameter change unit 27 changes the values of parameter candidates included in the previous response of the request specified in step S16 into values different from each other in the sets of request and response stored in the communication history storage device 3.

The parameter change unit 27 registers the changed sets of request and response with the registered data storage unit 26T in the pseudo server unit 26 (step S17). The processing in step S17 is an example of change processing.

The address change unit 25 changes the address of a request provided from the request issue unit 24 to the pseudo server unit 26. By referencing the registered data storage unit 26T, the pseudo server unit 26 provides a response associated with the received request to the request issue unit 24. The parameter candidates included in the response provided from the pseudo server unit 26 to the request issue unit 24 have their values changed by the parameter change unit 27.

The request issue unit 24 issues a request that received a parameter from the previous response. The target site specifying unit 28 stores the set of the request and the response in the observed data storage unit 28T.

Values of the parameter candidates included in the response have been changed. By referencing the observed data storage unit 28T, the target site specifying unit 28 compares the receiving parameter in the request with the values of the parameter candidates in the previous response (step S18).

Values of the parameter candidates included in the previous response have been changed by the parameter change unit 27. The target site specifying unit specifies a parameter candidate with a value that is the same as the receiving parameter and also specifies the site in the previous response at which the specified parameter candidate is present (step S19).

As a result, a parameter passed on from a response to a request can be specified. The target site specifying unit 28 generates target site specifying information that indicates the site in a response at which the parameter passed on to a request is present (step S20).

The above-described parameter specifying processing is performed for each request and for each parameter. Pieces of the target site specifying information that are collectively gathered for each request and for each parameter to be parameter specifying information. This parameter specifying information is output to the access reproduction device 13.

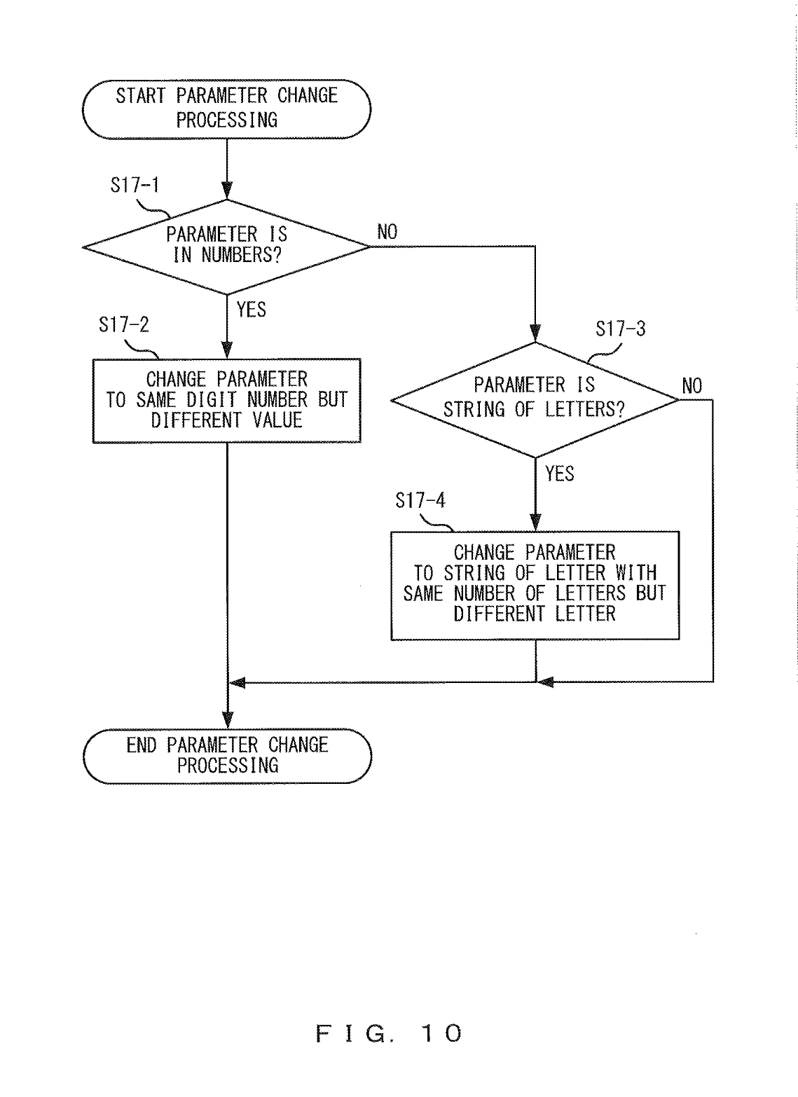

Next, an example of parameter change processing to change the value of parameter performed by parameter change unit 27 is explained with reference to the example in FIG. 10. The parameter change unit 27 determines whether plural parameter candidates are in numbers (step S17-1).

When step S17-1 is YES, the parameter change unit 27 changes the plural parameter candidates so that the numbers of the parameter candidates are in the same number of digits but different values (step S17-2).

When step S17-1 is NO, the parameter change unit 27 determines whether each of the plural parameter candidates is a string of letters (step S17-3). When step S17-3 is YES, the parameter change unit 27 changes a string of letters of each of the plural parameter candidates into a string of letters with the same number of letters but in different order of letters (step S17-4).

After the processing in step S17-2 is ended, after the processing in step S17-4 is ended, or when step S17-3 is NO, the parameter change processing is ended.

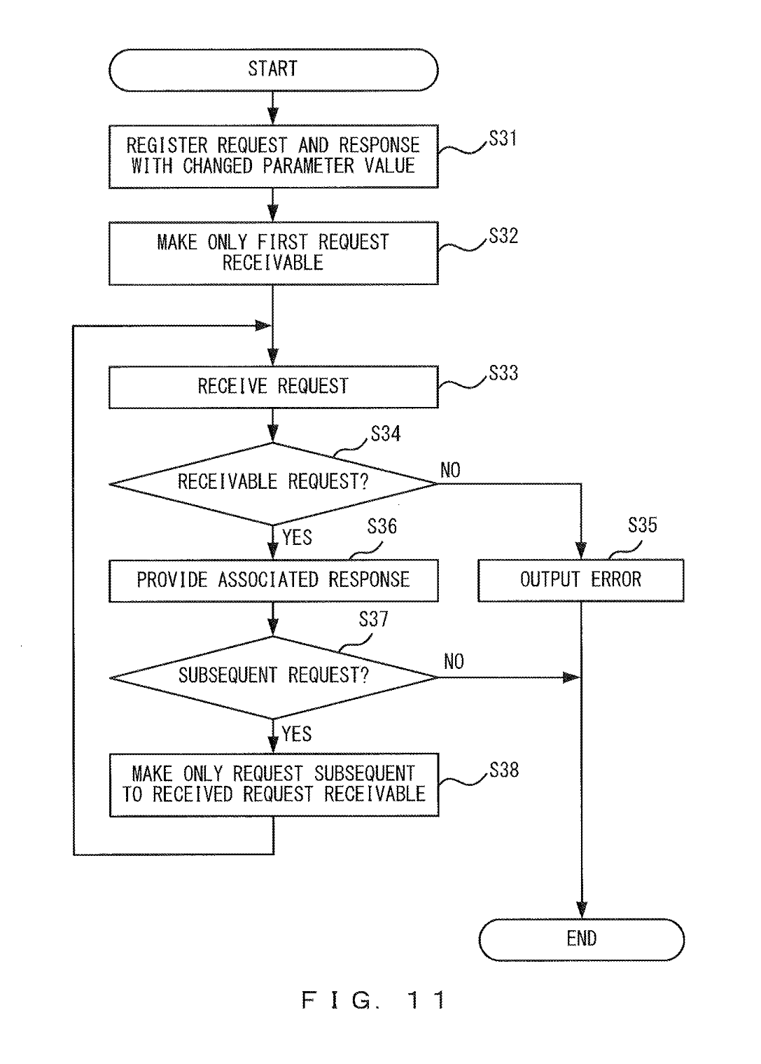

Next, operations of the pseudo server unit 26 are explained with reference to a flowchart of an example in FIG. 11. The pseudo server unit 26 registers sets of a request with a changed value of parameter and a response with a value of parameter changed by the parameter change unit 27 in the registered data storage unit 26T (step S31).

The pseudo server unit 26 receives only the first request issued by the request issue unit 24 (step S32). When the pseudo server unit 26 receives a request from the request issue unit 24 (step S33), the pseudo server unit 26 determines whether the request is a receivable request (step S34).

In the case in which only the first request is made receivable by the pseudo server unit 26, for example, when the request that the pseudo server unit 26 received is not the first request, the pseudo server unit 26 determines that the request is not receivable (NO in step S34). In this case, the pseudo server unit 26 outputs an error (step S35), and the processing is ended.

When the pseudo server unit 26 receives a receivable request (YES in step S34), with reference to the registered data storage unit 26T, the pseudo server unit 26 provides the response associated with the received request to the request issue unit 24 (step S36).

With reference to the registered data storage unit 26T, the pseudo server unit 26 determines whether there is a request subsequent to the received request (step S37). When the subsequent request is not found (NO in step S37), the processing is ended.

When a subsequent request is found, only the subsequent request is made receivable by the pseudo server unit 26 (step S38). Then the processing goes back to step S33.

As a result of the above-described processing, the pseudo server unit 26 can receive requests in accordance with the order of requests issued by the request issue unit 24. The request issue unit 24 is realized by the request issue processing and the pseudo server unit 26 is realized by the pseudo server processing.

When a request is received in accordance with the order of issue of requests issued by the request issue processing, the pseudo server processing provides a response associated with the received request to the request issue processing. Meanwhile, when a request is received in an order that is different from the order of issue of requests issued by the request issue processing, the pseudo server processing outputs an error.

### <Example of Hardware Configuration of Parameter Specifying Device>

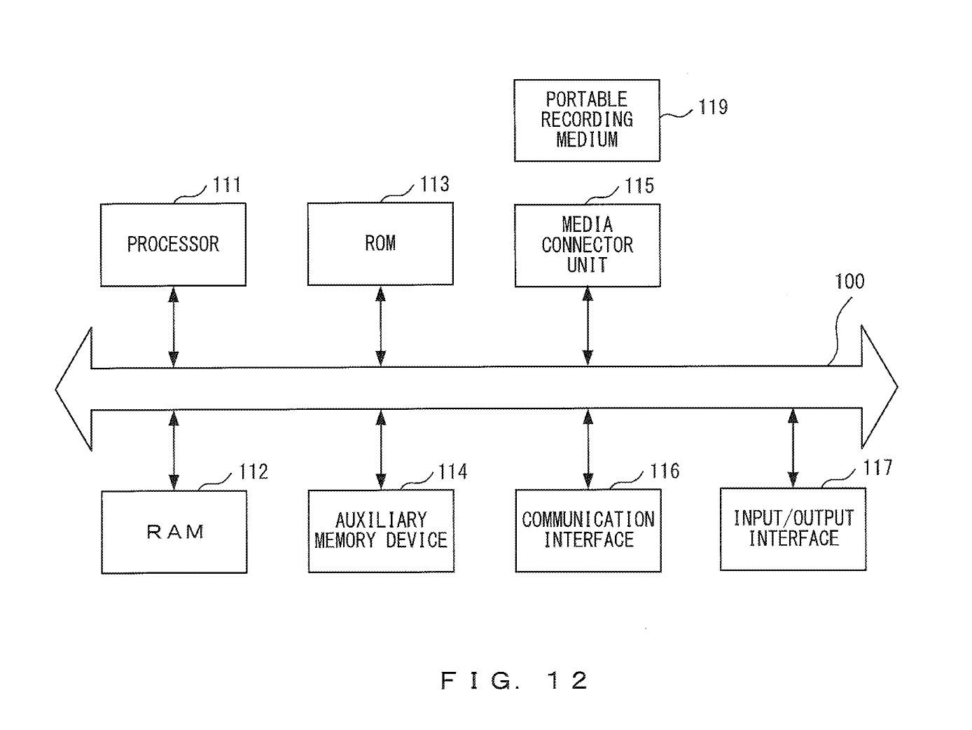

Next, an example of a hardware configuration of the parameter specifying device 14 is explained with reference to an example in FIG. 12. As illustrated in the example in FIG. 12, a processor 111, RAM 112, ROM 113, an auxiliary memory device 114, a media connector unit 115, a communication interface 116, and an input/output interface 117 are connected to a bus 100. In FIG. 12, an interface is abbreviated as “IF”.

The processor 111 is any processing circuit. The processor 111 executes a program loaded to RAM 112. The executed program may be a program that performs the processing according to the present embodiment. ROM 113 is a nonvolatile memory device that stores the program loaded to RAM 112.

The auxiliary memory device 114 is a memory device stores various information, and a hard disk drive or a semiconductor memory, for example, may be used as the auxiliary memory device 114. The media connector unit 115 is provided so as to be connectable with a portable recording medium 119.

For the portable recording medium 119, a portable memory or optical disk (e.g., Compact Disc (CD), Digital Versatile Disc (DVD), etc.) may be used. This portable recording medium 119 may record the program that performs the processing according to the present embodiment.

The input/output interface 117 is an interface for data input/output between an external device (e.g., the communication history storage device 3 or the access reproduction device 13) and the parameter specifying device 14.

In the parameter specifying device 14, the input unit 21 and the output unit 29 may be realized by the input/output interface 117. The registered data storage unit 26T and the observed data storage unit 28T may be realized by RAM 112 or the auxiliary memory device 114. Other components in the parameter specifying device 14 may be realized by the processor 111 executing given parameter specifying programs.

Each of RAM 112, ROM 113, the auxiliary memory device 114, and the portable recording medium 119 is an example of tangible computer-readable recording media. These tangible media are not a transitory medium such as a signal carrier wave.

### OTHERS

According to the above-described embodiment, it is possible to specify a parameter passed on from a response to a request.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable recording medium having stored therein an access information management program for causing a computer to execute a process comprising:
extracting a parameter from request data based on a storage device configured to store a plurality of pieces of the request data and response data associated with each of the plurality of pieces of the request data;
changing a plurality of parameters with a value that is the same as the extracted parameter into values different from each other from among a plurality of parameters included in previous response data that is before target request data including the extracted parameter; and
specifying a parameter passed on from the previous response data to the target request data based on a value of a parameter included in request data generated in accordance with a prescribed rule from the response data in which parameter values are changed by the changing.

2. The non-transitory computer-readable recording medium according to claim 1, wherein
in the specifying, processing that compares the response data in which parameter values are changed with the generated request data and specifies that a parameter with a value that agrees with each other is the parameter passed on from the previous response data to the target request data is executed.

3. The non-transitory computer-readable recording medium according to claim 1, wherein
in the changing, processing that when a last response data before the target request data does not include a parameter with a value that agrees with the extracted parameter, changes a plurality of parameters included in second to the last or more prior response data before the target request data into values different from each other is executed.

4. The non-transitory computer-readable recording medium according to claim 1, wherein
in the changing, processing that changes a numerical value of parameter that is the same as the extracted parameter into numerical values in the same number of digits but different from each other.

5. The non-transitory computer-readable recording medium according to claim 1, wherein
in the changing, processing that changes text information of parameter that is the same as the extracted parameter into text information in the same number of letters but in different order.

6. A parameter specifying method conducted by a computer, the parameter specifying method comprising:
extracting a parameter from request data based on a storage device configured to store a plurality of pieces of the request data and response data associated with each of the plurality of pieces of the request data;
changing a plurality of parameters with a value that is the same as the extracted parameter into values different from each other from among a plurality of parameters included in previous response data that is before target request data including the extracted parameter; and
specifying a parameter passed on from the previous response data to the target request data based on a value of a parameter included in request data generated in accordance with a prescribed rule from the response data in which parameter values are changed by the changing.

7. A parameter specifying device comprising:
a storage device; and
a processor configured to execute a process including:
extracting a parameter from request data based on a storage device configured to store a plurality of pieces of the request data and response data associated with each of the plurality of pieces of the request data;
changing a plurality of parameters with a value that is the same as the extracted parameter into values different from each other from among a plurality of parameters included in previous response data that is before target request data including the extracted parameter; and
specifying a parameter passed on from the previous response data to the target request data based on a value of a parameter included in request data generated in accordance with a prescribed rule from the response data in which parameter values are changed by the changing.
